(19) United States
(12) Patent Application Publication
(10) Pub. No.: US 2024/0359212 A1
(43) Pub. Date: Oct. 31, 2024

(54) ULTRASONIC DEVICE AND METHOD OF FORMING THE SAME, ULTRASONIC ASSEMBLIES AND METHODS OF FORMING THE SAME

(71) Applicant: Infineon Technologies AG, Neubiberg, DE (US)

(72) Inventors: Klaus ELIAN, Alteglofsheim (DE); Daniel OBERMEIER, Thanheim (DE); Emanuel STOICESCU, Bucharest (RO)

(21) Appl. No.: 18/638,045

(22) Filed: Apr. 17, 2024

(30) Foreign Application Priority Data
Apr. 27, 2023 (DE) 102023203937.0

(51) Int. Cl. B06B 1/02; B06B 1/06

(52) U.S. Cl. CPC B06B 1/0292; B06B 1/0207; B06B 1/0622; B06B 2201/51; B06B 2201/55

(57) ABSTRACT

An ultrasonic device is provided. The ultrasonic device includes at least one micromachined ultrasonic transducer (MUT) and processing circuitry electrically coupled to the at least one MUT. The at least one MUT and the processing circuitry are packed in an embedded wafer level ball grid array (eWLB) package. An acoustic coupling medium for acoustic coupling of the at least one MUT to an external application surface is formed on the at least one MUT.

### CROSS-REFERENCE TO RELATED APPLICATION

This application claims priority to German Patent Application No. 102023203937.0 filed on Apr. 27, 2023, the content of which is incorporated by reference herein in its entirety.

### TECHNICAL FIELD

The present disclosure relates to structures using Micromachined Ultrasonic Transducers (MUTs). In particular, examples of the present disclosure relate to ultrasonic devices and a method of forming the same as well as ultrasonic assemblies and methods of forming the same.

### BACKGROUND

MUTs are miniaturized sensor structures whose electrostatic operating principle enables the transmission and detection of ultrasonic waves. Like for other ultrasonic sensors, it is desired for MUTs to have a void free interface to application surfaces such as customer surfaces.

Hence, there may be a demand for MUT based structures that allow to provide a void free interface to application surfaces.

### SUMMARY

This demand is met by the subject-matter of the independent claims. Advantageous implementations are addressed by the dependent claims.

According to a first aspect, the present disclosure provides an ultrasonic device. The ultrasonic device includes at least one MUT and processing circuitry electrically coupled to the at least one MUT. The at least one MUT and the processing circuitry are packed in an embedded Wafer Level Ball grid array (eWLB) package. An acoustic coupling medium for acoustic coupling of the at least one MUT to an external application surface is formed on the at least one MUT.

According to a second aspect, the present disclosure provides an ultrasonic assembly. The ultrasonic assembly includes a Printed Circuit Board (PCB) and an ultrasonic device according to the first aspect. The ultrasonic device is assembled to the PCB. The acoustic coupling medium protrudes through a recess formed in the PCB.

According to a third aspect, the present disclosure provides a method of forming an ultrasonic device. The method includes providing an eWLB package. At least one MUT and a processing circuitry electrically coupled to the at least one MUT are packed in the eWLB package. Additionally, the method includes forming an acoustic coupling medium for acoustic coupling of the at least one MUT to an external application surface on the at least one MUT.

According to a fourth aspect, the present disclosure provides a method of forming an ultrasonic assembly. The method includes providing an eWLB package. At least one MUT and a processing circuitry electrically coupled to the at least one MUT are packed in the eWLB package. Additionally, the method includes assembling the eWLB package to a PCB. A recess is provided in the PCB. The method further includes forming an acoustic coupling medium for acoustic coupling of the at least one MUT to an external application surface on the at least one MUT after assembling the eWLB package to the PCB such that the acoustic coupling medium protrudes through the recess.

According to a fifth aspect, the present disclosure provides another method of forming an ultrasonic assembly. The method includes providing an ultrasonic device according to the first aspect and assembling the ultrasonic device to a PCB such that the acoustic coupling medium protrudes through a recess formed in the PCB.

According to a sixth aspect, the present disclosure provides another ultrasonic assembly. The ultrasonic assembly includes a PCB and additionally at least one MUT packed in a Wafer Level Ball grid array (WLB) package. The WLB package is assembled to the PCB. An acoustic coupling medium for acoustic coupling of the at least one MUT to an external application surface is formed on the at least one MUT such that the acoustic coupling medium protrudes through a recess formed in the PCB.

According to a seventh aspect, the present disclosure provides another method of forming an ultrasonic assembly. The method includes providing at least one MUT packed in a WLB package. An acoustic coupling medium for acoustic coupling of the at least one MUT to an external application surface is formed on the at least one MUT. In addition, the method includes assembling the at least one MUT to a PCB such that the acoustic coupling medium protrudes through a recess formed in the PCB.

According to an eighth aspect, the present disclosure provides a further method of forming an ultrasonic assembly. The method includes providing at least one MUT packed in a WLB package. Additionally, the method includes assembling the at least one MUT to a PCB. The method further includes forming an acoustic coupling medium for acoustic coupling of the at least one MUT to an external application surface on the at least one MUT after assembling the at least one MUT to the PCB such that the acoustic coupling medium protrudes through the recess.

### BRIEF DESCRIPTION OF THE DRAWINGS

Some examples of apparatuses and/or methods will be described in the following by way of example only, and with reference to the accompanying figures, in which:

FIG. 1 schematically illustrates a sectional view of a first example ultrasonic device;

FIG. 2 schematically illustrates a sectional view of a second example ultrasonic device;

FIG. 3 schematically illustrates a sectional view of a third example ultrasonic device;

FIG. 4 illustrates a flowchart of an example of a method of forming an ultrasonic device;

FIG. 5 and FIG. 6 schematically illustrate a process of forming an acoustic coupling medium on an eWLB package;

FIG. 7 schematically illustrates a sectional view of a first example ultrasonic assembly;

FIG. 8 illustrates a flowchart of a first example of a method of forming an ultrasonic assembly;

FIG. 9 schematically illustrates a first example process of forming the first example ultrasonic assembly illustrated in FIG. 7;

FIG. 10 illustrates a flowchart of a second example of a method of forming an ultrasonic assembly;

FIG. 11 and FIG. 12 schematically illustrate a second example process of forming the first example ultrasonic assembly illustrated in FIG. 7;

FIG. 13 schematically illustrates a sectional view of a second example ultrasonic assembly;

FIG. 14 illustrates a flowchart of a third example of a method of forming an ultrasonic assembly; and

FIG. 15 illustrates a flowchart of a fourth example of a method of forming an ultrasonic assembly.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

FIG. 1 illustrates an example ultrasonic device 100.

The ultrasonic device 100 comprises two MUTs 111 and 112. A MUT is a MicroElectroMechanical System (MEMS)-based ultrasonic transducer. The MUT is configurable to detect ultrasonic waves received from the environment and/or to generate and emit ultrasonic waves to the environment. The energy transduction by the MUT may be based on various effects such as capacity and piezoelectricity. In other words, an MUT referred to in the present disclosure may be a Capacitive Micromachined Ultrasonic Transducer (CMUT) or a Piezoelectric Micromachined Ultrasonic Transducer (PMUT). A CMUT comprises two electrodes, wherein one of the electrodes is fixed and the other electrode is encapsulated, integrated or formed by a movable membrane of the MUT. The membrane electrode is separated from the fixed electrode by a small gas filled gap (e.g., an air gap) such that the membrane electrode can move relative to the fixed electrode. A PMUT comprises a movable membrane coupled to or formed by a piezoelectric member (device, structure). In general, the MUTs 111 and 112 may be configured to emit and/or detect sound waves at least between 20 kHz and 1 GHz and/or any sub-range thereof. In particular, the MUTs 111 and 112 may be configured to emit and/or detect low frequency ultrasonic waves (e.g., at approx. 50 kHz) for applications in air such as proximity detection (e.g., for parking sensors of vehicles) or high frequency ultrasonic waves (e.g., at approx. 2 to 10 MHZ) for diagnostics applications (e.g., medial ultrasound).

The ultrasonic device 100 further comprises processing circuitry 120 electrically coupled to the MUTs 111 and 112. The processing circuitry 120 is configured to control the MUTs 111 and 112 and to process the output signals of the MUTs 111 and 112. The processing circuitry 120 may be implemented in various ways. For example, the processing circuitry 120 may be or comprise an Application Specific Integrated Circuit (ASIC), a Field Programmable Gate Array (FPGA), a processor or a combination thereof. The processing circuitry 120 may optionally be coupled to or comprise memory storing a program having a program code for causing the processing circuitry 120 to perform the functionalities described herein, when the program is executed by the processing circuitry 120.

For example, the processing circuitry 120 may be configured to control one or both of the MUTs 111 and 112 to emit ultrasonic waves. Additionally, or alternatively, the processing circuitry 120 may be configured to process one or more output signals of one or both of the MUTs 111 and 112. The one or more output signals are generated by one or both of the MUTs 111 and 112 based on received ultrasonic waves (e.g., reflections of previously emitted ultrasonic waves). In other words, the MUTs 111 and 112 may be operated as ultrasonic emitters and/or as ultrasonic receivers (detectors) by the processing circuitry 120. For example, for controlling a CMUT to emit ultrasonic waves, the processing circuitry 120 may, e.g., be configured to supply (apply) to the electrodes of the CMUT a DC voltage for biasing the electrodes and an AC voltage to actuate the membrane. For controlling a CMUT to act as an ultrasonic receiver (detector), the processing circuitry 120 may, e.g., be configured to supply (apply) a DC voltage to the electrodes of the CMUT for biasing the electrodes and to measure the voltage variation between the electrodes, which is caused by the capacitance variation due to the movement of the membrane by the received ultrasonic waves. Similarly, for controlling a PMUT to emit ultrasonic waves, the processing circuitry 120 may, e.g., be configured to supply (apply) an AC voltage to the piezoelectric member to actuate the membrane by the induced deflection of the piezoelectric member. For controlling a PMUT to act as an ultrasonic receiver (detector), the processing circuitry 120 may, e.g., be configured to measure the voltage output by the piezoelectric member due to the deflection of the piezoelectric member by the received ultrasonic waves.

The MUTs 111 and 112 and the processing circuitry 120 are packed (packaged, assembled, mounted) in an eWLB package 130. The eWLB package 130 is formed in an cWLB packaging process. As illustrated in FIG. 1, the MUTs 111 and 112 are embedded in a mold compound 131 of the eWLB package 130. For example, the mold compound 131 may be an epoxy mold compound, a thermoplastic mold compound such as PolyPhenylene Sulfide (PPS), PolyStyre (PS), PolyPropylene (PP), PolyCarbonate (PC), PolyButylene Succinate (PBS) or Liquid Crystal Polymer (LCP), a duroplast mold compound, a foamed plastic mold compound, or a combination thereof. However, it is to be noted that the present disclosure is not limited to the foregoing examples. In the example of FIG. 1, two redistribution layers 132 and 133 are formed on the mold compound 131 for electrically coupling the processing circuitry 120 to the MUTs 111 and 112 and for electrically coupling the processing circuitry 120 to interconnects of the eWLB package 130 such as the two interconnects 134 and 135 illustrated in FIG. 1. Corresponding conductive traces such as the conductive trace 137 are formed in the redistribution layers 132 and 133 for electrically coupling the respective elements. However, it is to be noted that the present disclosure is not limited thereto. In general, the eWLB package 130 may comprise any number M≥1 of redistribution layers and any number L≥1 of interconnects. The interconnects may, e.g., be solder balls as illustrated in FIG. 1 for the two interconnects 134 and 135.

A recess 136 is provided in redistribution layers 132 and 133 at a position of (above) the MUTs 111 and 112 for an acoustic coupling medium 140. The acoustic coupling medium 140 is for acoustic coupling of the MUTs 111 and 112 to an external application surface (not illustrated in FIG. 1). The external application surface is a surface external to the ultrasonic device 100 to which the ultrasonic device 100 may be mounted (directly or indirectly). The external application surface is arranged between the ultrasonic device 100, e.g., the MUTs 111 and 112, and an object (e.g., a finger or hand) or space volume to be monitored, tracked etc. The external application surface may, e.g., be a housing or an operating panel of a device/application comprising the ultrasonic device 100 such as the operating panel of a consumer electronics device or an operating panel of a vehicle (e.g., a car, a truck, a train, an airplane, a ship, etc.) for touch inputs. The acoustic coupling medium 140 is a substance or material facilitating the transmission of ultrasonic waves between the external application surface and the MUTs 111 and 112. The acoustic coupling medium 140 serves as a medium for the ultrasonic waves to travel through, ensuring that there is minimal loss of energy as the ultrasonic waves pass from the MUT through the acoustic coupling medium 140 and into the external application surface, and vice versa.

The acoustic coupling medium 140 is formed on the MUTs 111 and 112. In particular, the acoustic coupling medium 140 is formed on the respective membrane of the MUTs 111 and 112. The acoustic coupling medium 140 allows to contact the external application surface such that a void between the external application surface and the MUTs 111 and 112 may be avoided. The acoustic coupling medium 140 protrudes from the eWLB package 130 such that it can be brought into contact with the external application surface. For example, the acoustic coupling medium 140 may protrude from the eWLB package 130 and be pressable against the external application surface to avoid air gaps (or in general gas filled gaps) between the external application surface and the MUTs 111 and 112.

Furthermore, the acoustic coupling medium 140 is a medium for impedance matching between the acoustic impedance of the MUTs 111 and 112 and the acoustic impedance of the external application surface. Accordingly, the acoustic impedance of the acoustic coupling medium 140 may be lower than an acoustic impedance of the MUTs 111 and 112. Similarly, the acoustic impedance of the acoustic coupling medium 140 may be higher than the acoustic impedance of the external application surface.

The acoustic coupling medium 140 may, e.g., be a gel. However, the present disclosure is not limited thereto. In other examples, acoustic coupling medium 140 may, e.g., be a cream or an oil. The acoustic coupling medium 140 may comprise various substances such as, e.g., silicone or b-stageable epoxy. However, the present disclosure is not limited to the foregoing substances. In general, any suitable substance may be used for the acoustic coupling medium 140. The composition of the acoustic coupling medium 140 may, e.g., depend on the specific application and, hence, the frequency range of the ultrasonic waves emitted and/or to be detected by the MUTs 111 and 112.

In the example of FIG. 1, the ultrasonic device 100 comprises two MUTs 111 and 112. However, it is to be noted that the ultrasonic device 100 is not limited thereto. In general, the ultrasonic device 100 may comprise any number N≥1 of MUTs packed (packaged, assembled, mounted) in the eWLB package 130. In other words, in a basic configuration, the ultrasonic device 100 comprises at least one MUT and the processing circuitry 120 electrically coupled to the at least one MUT. Analogously to what is described above, the at least one MUT and the processing circuitry 120 are packed in the eWLB package 130 and the acoustic coupling medium 140 for acoustic coupling of the at least one MUT to an external application surface is formed on the at least one MUT. Analogously to what is described above, the processing circuitry 120 may be configured to control the at least one MUT to selectively emit ultrasonic waves and/or to process one or more output signals of the at least one MUT. The one or more output signals are generated by the at least one MUT based on received ultrasonic waves.

Optionally the ultrasonic device 100 may comprise further electronic components such as, e.g., one or more amplifiers for amplifying one or more signals within the ultrasonic device 100, one or more passive electronic components (such as resistors, capacitances or inductors) or one or more Light-Emitting Diodes (LEDs) for status indication.

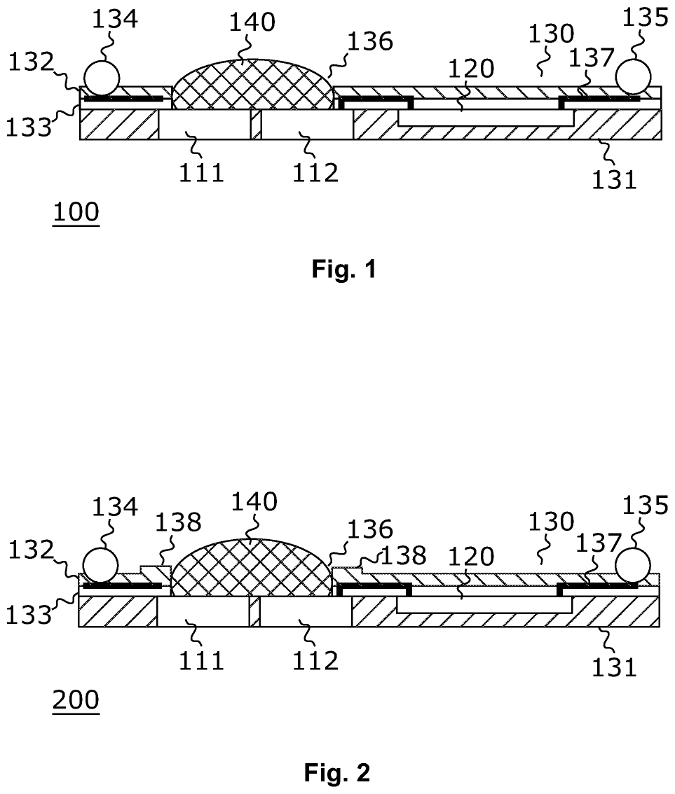

FIG. 2 illustrates another ultrasonic device 200. The ultrasonic device 200 differs from the ultrasonic device 100 described above in that a protrusion 138 surrounding the recess 136 is additionally formed on the redistribution layers 132 and 133. The protrusion 138 serves for generating a predetermined lens shape with a low viscosity coupling medium in an uncured state, and as an expansion stop to hinder the acoustic coupling medium 140 from expanding to (covering) the redistribution layers 132 and 133 or any other elements formed (arranged) on the redistribution layers 132 and 133 such as the interconnects 134 and 135. The acoustic coupling medium 140 protrudes from the protrusion 138 such that it can be brought into contact with the external application surface. The protrusion 138, may, e.g., be formed by one or more passivation layers formed on the redistribution layers 132 and 133. However, the present disclosure is not limited thereto.

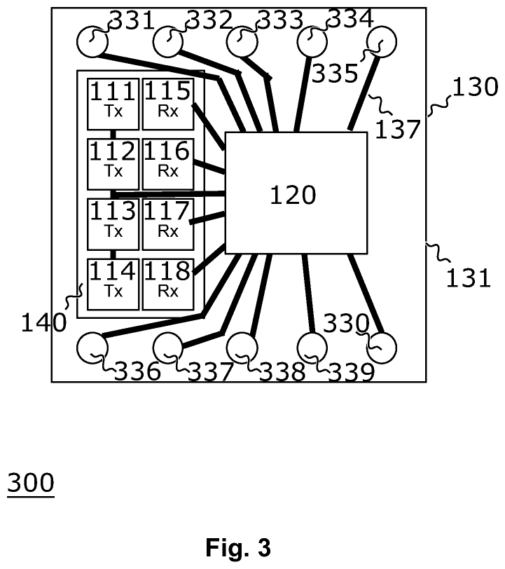

As indicated above, an ultrasonic device according to the present disclosure may comprise any number N≥1 of MUTs. FIG. 3 illustrates another ultrasonic device 300 comprising eight MUTs 111, . . . , 118 embedded in the mold compound 131 of the eWLB package 130. The MUTs 111, . . . , 118 are electrically coupled to the processing circuitry 120 via conductive traces in one or more redistribution layers (not explicitly illustrated in FIG. 3 due to the perspective) of the eWLB package 130. Similarly, the processing circuitry 120 is electrically coupled via conductive traces in the one or more redistribution layers to the interconnects 330, . . . , 339 of the eWLB package 130. For reasons of simplicity only the conductive trace electrically coupling the processing circuitry 120 and the interconnect 135 is provided with a reference sign, namely the reference sign 137.

In the example of FIG. 3, half of the MUTs 111, . . . , 118 are operated as ultrasonic transmitters and the other MUTs are operated as ultrasonic receivers. In particular, the processing circuitry 120 is configured to control the MUTs 111, . . . , 114 to act as ultrasonic transmitters and emit ultrasonic waves. Analogously, the processing circuitry 120 is configured to process the output signals of the MUTs 115, . . . , 118 acting as ultrasonic receivers. The output signals generated by the MUTs 115, . . . , 118 are based on received ultrasonic waves (e.g., reflection of the ultrasonic waves emitted by the MUTs 111, . . . , 114).

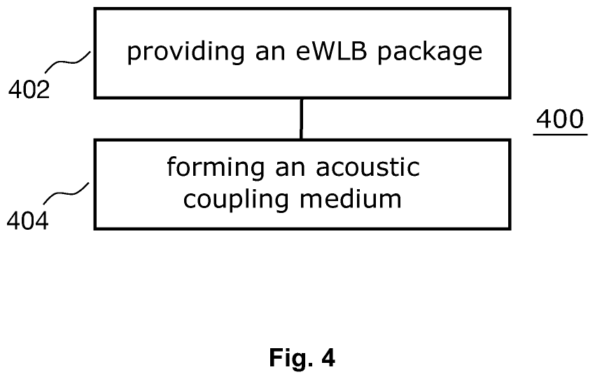

A flowchart of an example method 400 of forming an ultrasonic device as described above is illustrated in FIG. 4. The method 400 comprises providing 402 an eWLB package. At least one MUT and a processing circuitry electrically coupled to the at least one MUT are packed in the eWLB package. For example, the eWLB package may be formed in an eWLB packaging process. Additionally, the method 400 comprises forming 404 an acoustic coupling medium for acoustic coupling of the at least one MUT to an external application surface on the at least one MUT.

The method 400 allows to provide an ultrasonic device as described above. More details and aspects of the method 400 are explained in connection with the proposed technique or one or more example described above. The method 400 may comprise one or more additional optional features corresponding to one or more aspects of the proposed technique, or one or more example described above.

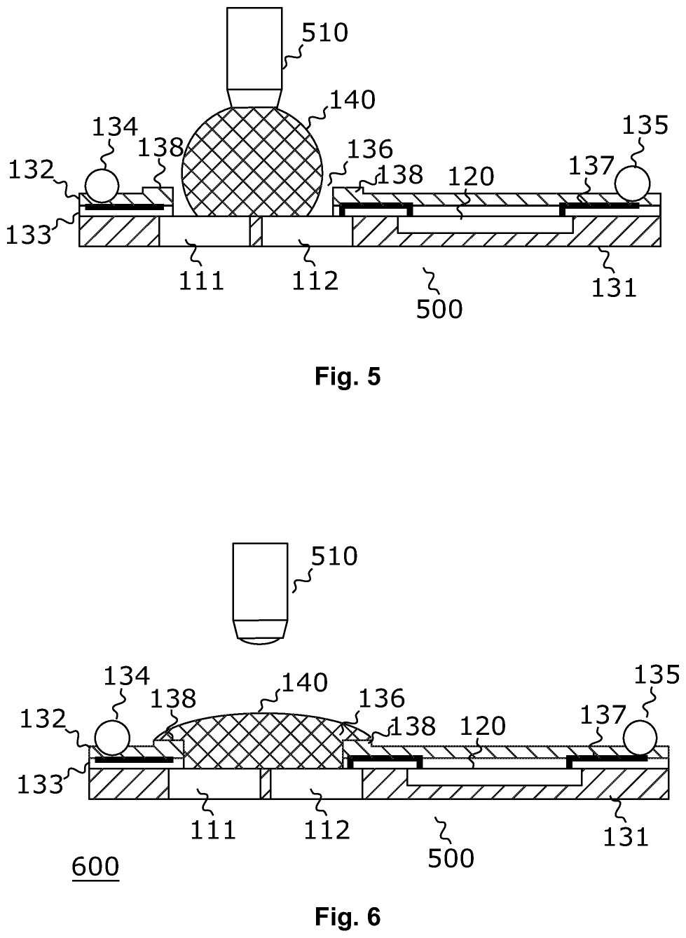

Forming 404 the acoustic coupling medium on the at least one MUT may, e.g., comprise dispensing a fluid, a cream or a gel as the acoustic coupling medium on the at least one MUT. This is exemplarily illustrated in FIG. 5 and FIG. 6. Like in the examples of FIG. 1 and FIG. 2, an eWLB package 500 with two MUTs 111 and 112 is illustrated in FIG. 5 and FIG. 6. FIG. 5 illustrates the dispensing of the fluid, cream or gel on the two MUTs 111 and 112 using a dispenser needle 510. Optionally, forming 404 the acoustic coupling medium 140 may further comprise curing the dispensed fluid, cream or gel. FIG. 6 illustrates the resulting ultrasonic device 600 with the acoustic coupling medium 140 formed on the two MUTs 111 and 112. The protrusion 138 prevents spreading of the fluid, cream or gel to the redistribution layers 131 and 132.

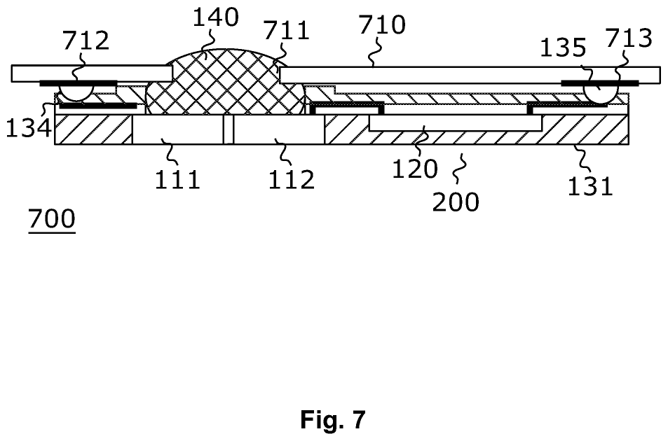

FIG. 7 illustrates an ultrasonic assembly 700 using an ultrasonic device as described above. In particular, the ultrasonic assembly 700 comprises the ultrasonic device 200 described above. Additionally, the ultrasonic assembly 700 comprises a PCB 710 (e.g., a rigid PCB or a flexible PCB). The ultrasonic device 200 is assembled (mounted) to the PCB 710 such that the acoustic coupling medium 140 protrudes through a recess 711 (e.g., a hole) formed in the PCB 710. In other words, the coupling medium 140 pears through the recess 711. The interconnects 134 and 135 of the eWLB package 130 are electrically coupled to conductive traces 712 and 713 on the PCB 710. For example, the interconnects 134 and 135 may be soldered to the conductive traces 712 and 713 on the PCB 710. In the example of FIG. 7, two conductive traces 712 and 713 are illustrated. However, it is to be noted that the PCB 710 may comprise any suitable number T≥1 of conductive traces.

For example, the ultrasonic device 200 may be provided by a semiconductor manufacturer and the PCB 710 may be a PCB of a customer. Accordingly, an ultrasonic assembly 700 according to the customer's specifications may be provided. The acoustic coupling medium 140 protruding through the recess 711 allows to contact an external application surface to which the ultrasonic assembly 700 may be mounted. Accordingly, a void between the external application surface and the MUTs 111 and 112 may be avoided.

In the example of FIG. 7, the ultrasonic device 200 comprises two MUTs 111 and 112. However, it is to be noted that the ultrasonic assembly 700 is not limited thereto. In general, an ultrasonic device comprising any number N≥1 of MUTs packed (packaged, assembled, mounted) in the eWLB package may be used.

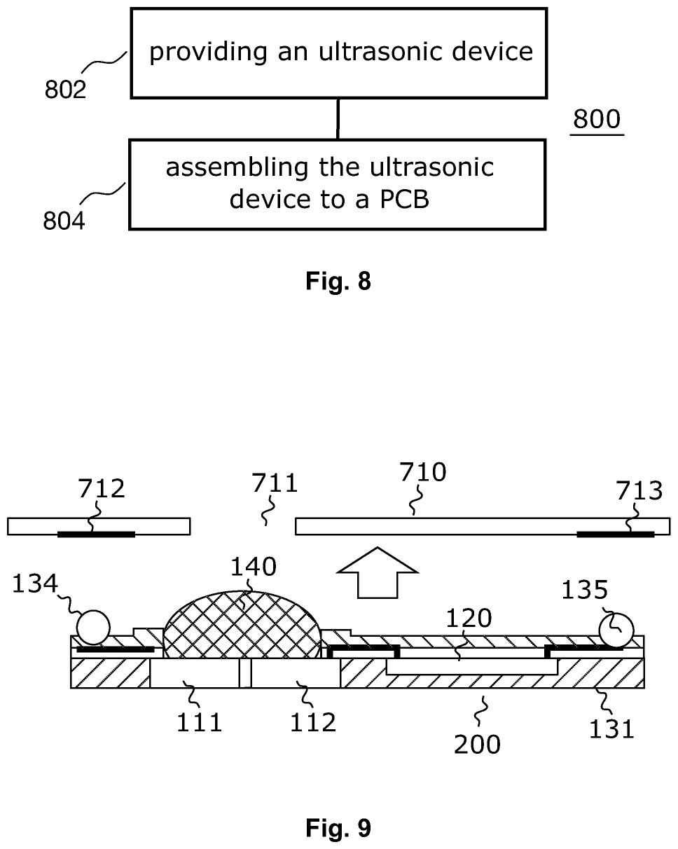

A flowchart of a first example method 800 of forming an ultrasonic assembly as described above is illustrated in FIG. 8. The method 800 comprises providing 802 an ultrasonic device as described above (e.g., one of the ultrasonic device 100, 200 and 300) and assembling 804 the ultrasonic device to a PCB such that the acoustic coupling medium of the ultrasonic device protrudes through a recess formed in the PCB.

The method 800 allows to provide an ultrasonic assembly as described above. More details and aspects of the method 800 are explained in connection with the proposed technique or one or more example described above. The method 800 may comprise one or more additional optional features corresponding to one or more aspects of the proposed technique, or one or more example described above.

To further highlight the method 800, FIG. 9 example illustrates the corresponding process of mounting the ultrasonic device 200 to the PCB 710 in order to obtain the ultrasonic assembly 700 described above with reference to FIG. 7. The interconnects 134 and 135 are electrically connected to the conductive traces 712 and 713 on the PCB 710. The PCB 710 is provided with the recess 711 such that the acoustic coupling medium 140 can protrude through the recess 711 after mounting.

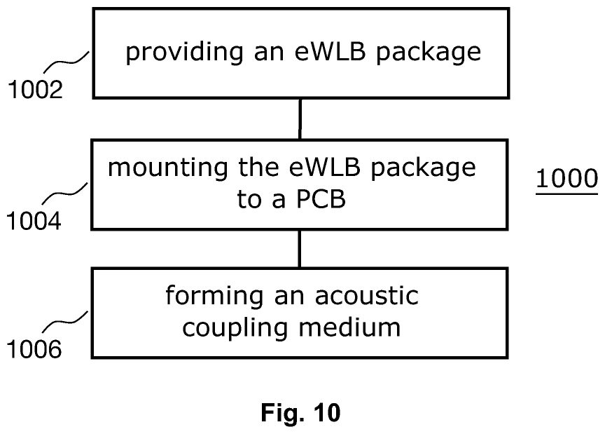

A flowchart of a second example method 1000 of forming an ultrasonic assembly as described above is illustrated in FIG. 10. The method 1000 comprises providing 1002 an eWLB package. At least one MUT and a processing circuitry electrically coupled to the at least one MUT are packed in the eWLB package. Additionally, the method 1000 comprises assembling 1004 the eWLB package to a PCB. A recess is provided in the PCB. The method 1000 further comprises forming 1006 an acoustic coupling medium for acoustic coupling of the at least one MUT to an external application surface on the at least one MUT after assembling the eWLB package to the PCB such that the acoustic coupling medium protrudes through the recess.

While the acoustic coupling medium is formed before the mounting (assembly) to the PCB in the method 800, the acoustic coupling medium is formed after the mounting (assembly) to the PCB in the method 1000. In other words, the eWLB package used in the method 1000 may be similar to the eWLB packages described above—the only difference may be that no acoustic coupling medium is formed as this is done after the mounting (assembly) to the PCB in the method 1000. Also, the method 1000 allows to provide an ultrasonic assembly as described above. More details and aspects of the method 1000 are explained in connection with the proposed technique or one or more example described above. The method 1000 may comprise one or more additional optional features corresponding to one or more aspects of the proposed technique, or one or more example described above.

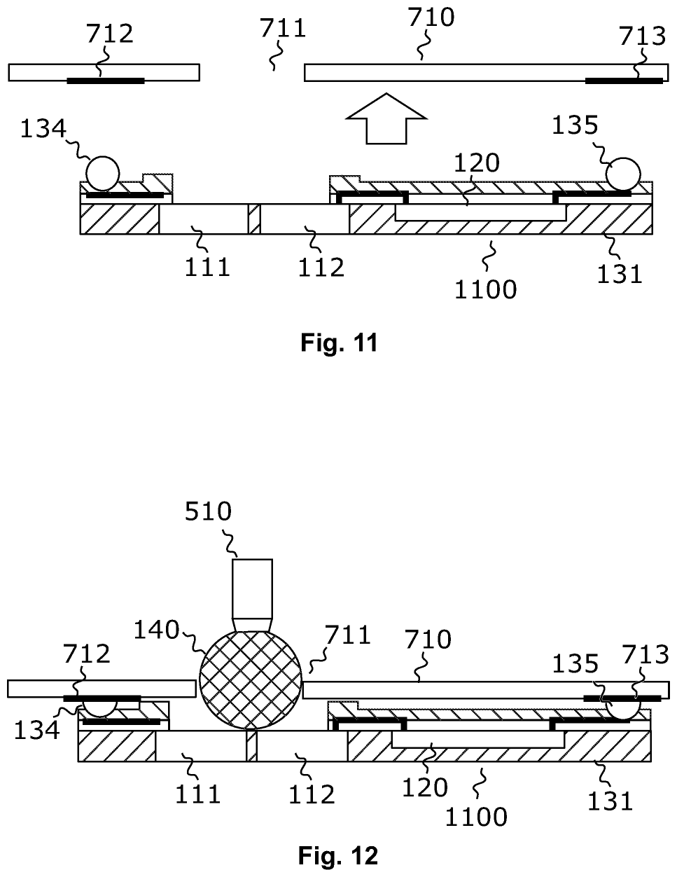

To further highlight the method 1000, FIGS. 11 and 12 example illustrate the corresponding process of forming the ultrasonic assembly 700 described above with reference to FIG. 7.

As illustrated in FIG. 11, an eWLB package 1100 (which is identical to the ultrasonic device 200 except for the omitted acoustic coupling medium 140) is mounted to the PCB 710 such that the interconnects 134 and 135 of the eWLB package 1100 are electrically connected to the conductive traces 712 and 713 on the PCB 710 (e.g., the interconnects may be soldered to the conductive traces). FIG. 12 illustrates the subsequent dispensing of the fluid, cream or gel on the two MUTs 111 and 112 using the dispenser needle 510 to form the acoustic coupling medium 140. Optionally, forming the acoustic coupling medium 140 may further comprise curing the dispensed fluid, cream or gel. Also, by forming the acoustic coupling medium 140 after mounting the eWLB package 1100 to the PCB 710, the acoustic coupling medium 140 may be formed to protrude through the recess 711 of the PCB 710.

In the above examples, the processing circuitry and the at least one MUT are packed in an eWLB package. However, the present disclosure is not limited thereto. As will be described below, WLB packages which are also known as Wafer-Level Packaging (WLP) packages may be used instead.

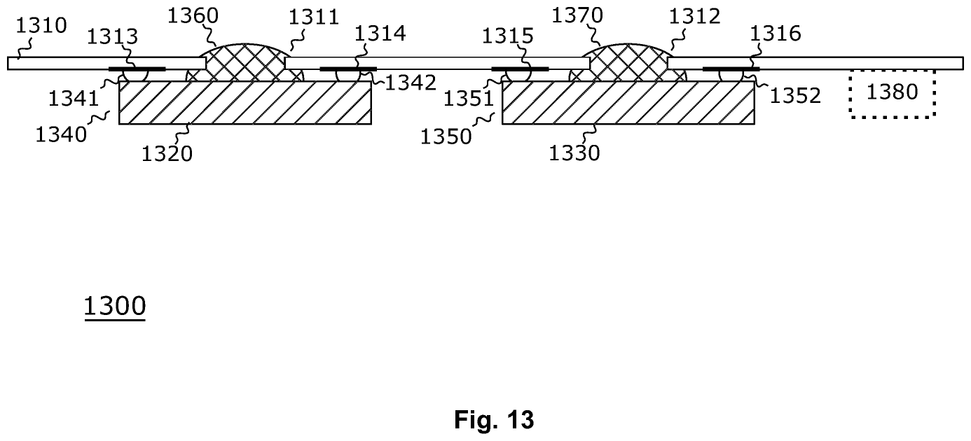

FIG. 13 illustrates an example ultrasonic assembly 1300 comprising a PCB 1310 and two MUTs 1320 and 1330. The MUTs 1320 and 1330 are each packed (packaged, assembled, mounted) in a respective WLB package 1340, 1350. The WLB packages 1340 and 1350 are formed in a WLB (WLP) packaging process.

Each of the WLB packages 1340 and 1350 comprises two respective interconnects 1341, 1342 and 1351, 1352 for connecting the respective WLB package 1340, 1350 to external entities such as the PCB 1310. In general, the WLB package 1340 and 1350 may comprise any number L≥1 of interconnects. The interconnects may, e.g., be solder balls as illustrated in FIG. 13.

The WLB packages 1340 and 1350 are both assembled to the PCB 1310 such that the interconnects 1341, 1342 and 1351, 1352 are electrically coupled to the conductive traces 1313, . . . , 1316 on the PCB 1310 (e.g., the interconnects may be soldered to the conductive traces).

An acoustic coupling medium 1360 for acoustic coupling of the MUT 1320 to an external application surface is formed on the MUT 1320 such that the acoustic coupling medium 1360 protrudes through a recess 1311 formed in the PCB 1310. Analogously, an acoustic coupling medium 1370 for acoustic coupling of the MUT 1330 to the external application surface is formed on the MUT 1330 such that the acoustic coupling medium 1370 protrudes through another recess 1312 formed in the PCB 1310. In particular, the respective acoustic coupling medium 1360, 1370 may be formed on the respective membrane of the MUTs 1320 and 1330.

The acoustic coupling media 1360 and 1370 allow to contact the external application surface such that a void between the external application surface and the MUTs 1320 and 1330 may be avoided. The acoustic coupling media 1360 and 1370 protrude from the PCB 1310 such that they can be brought into contact with the external application surface. For example, the acoustic coupling medium 1360 and 1370 may be pressable against the external application surface to avoid air gaps (or in general gas filled gaps) between the external application surface and the MUTs 1320 and 1330. The external application surface may be as described above with respect to the ultrasonic device 100.

In the example of FIG. 13, the ultrasonic assembly 1300 comprises two MUTs 1320 and 1330. However, it is to be noted that the ultrasonic assembly 1300 is not limited thereto. In general, the ultrasonic assembly 1300 may comprise any number A≥1 of MUTs packed in a respective WLB package. In other words, in a basic configuration, the ultrasonic assembly 1300 comprises a PCB and at least one MUT packed in a WLB package. Analogously to what is described above, the WLB package is assembled to the PCB and an acoustic coupling medium for acoustic coupling of the at least one MUT to an external application surface is formed on the at least one MUT such that the acoustic coupling medium protrudes through a recess formed in the PCB. In case of multiple MUTs packed in a respective WLB package, the respective acoustic coupling medium formed on the respective MUT may protrude through a respective recess formed in the PCB. In other examples, the acoustic coupling media of two or more MUTs may protrude through a same (common) recess formed in the PCB.

The ultrasonic assembly 1300 may optionally further comprise processing circuitry 1380 (which may be implemented analogously to the processing circuitry 120 described above). The processing circuitry 1380 is assembled to the PCB 1310 and electrically coupled to the at least one MUT of the ultrasonic assembly 1300 (e.g., via one or more conductive traces on the PCB 1310). For example, the processing circuitry 1380 may be packed in a separate WLB package. However, the present disclosure is not limited thereto. In general, any packing or assembly technology may be used for assembling the processing circuitry 1380 to the PCB 1310. Analogously to what is described above, the processing circuitry 1380 may be configured to control the at least one MUT of the ultrasonic assembly 1300 to selectively emit ultrasonic waves and/or to process one or more output signals of the at least one MUT, the one or more output signals being generated by the at least one MUT based on received ultrasonic waves. For example, the processing circuitry 1380 may be configured to control the MUT 1320 to emit ultrasonic waves to operate the MUT 1320 as an ultrasonic transmitter and to process the output signal(s) of the MUT 1330 acting as ultrasonic receiver. The output signal(s) generated by the MUT 1330 is/are based on received ultrasonic waves (e.g., reflections of the ultrasonic waves emitted by the MUT 1320).

Optionally the ultrasonic assembly 1300 may comprise further electronic components such as, e.g., one or more amplifiers for amplifying one or more signals within the ultrasonic assembly 1300, one or more passive electronic components (such as resistors, capacitances or inductors) or one or more LEDs for status indication.

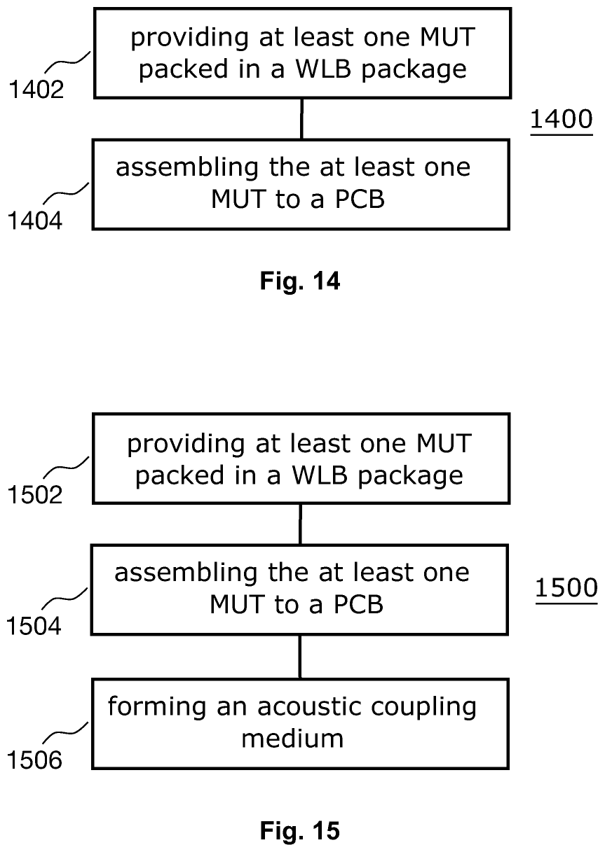

A flowchart of an example method 1400 of forming an ultrasonic assembly such as the ultrasonic assembly 1300 described above is illustrated in FIG. 14. The method 1400 comprises providing 1402 at least one MUT packed in a WLB package. An acoustic coupling medium for acoustic coupling of the at least one MUT to an external application surface is formed on the at least one MUT. In addition, the method 1400 comprises assembling 1404 the at least one MUT to a PCB such that the acoustic coupling medium protrudes through a recess formed in the PCB.

The method 1400 allows to provide an ultrasonic assembly such as the ultrasonic assembly 1300 described above. More details and aspects of the method 1400 are explained in connection with the proposed technique or one or more example described above. The method 1400 may comprise one or more additional optional features corresponding to one or more aspects of the proposed technique, or one or more example described above.

For example, for forming the ultrasonic assembly 1300 according to the method 1400, two MUTs packed in a respective WLB package may be provided. A respective acoustic coupling medium for acoustic coupling of the respective MUT to the external application surface is formed on each MUT. Then the two MUTs are assembled to the PCB such that the respective acoustic coupling medium formed on the respective MUT protrudes through a respective recess formed in the PCB.

A flowchart of an alternative method 1500 of forming an ultrasonic assembly such as the ultrasonic assembly 1300 described above is illustrated in FIG. 15. The method 1500 comprises providing 1502 at least one MUT packed in a WLB package. Additionally, the method 1500 comprises assembling 1504 the at least one MUT to a PCB. The method 1500 further comprises forming 1506 an acoustic coupling medium for acoustic coupling of the at least one MUT to an external application surface on the at least one MUT after assembling 1504 the at least one MUT to the PCB such that the acoustic coupling medium protrudes through the recess.

While the acoustic coupling medium is formed before the mounting (assembly) to the PCB in the method 1400, the acoustic coupling medium is formed after the mounting (assembly) to the PCB in the method 1500. Also, the method 1500 allows to provide an ultrasonic assembly such as the ultrasonic assembly 1300 described above. More details and aspects of the method 1500 are explained in connection with the proposed technique or one or more example described above. The method 1500 may comprise one or more additional optional features corresponding to one or more aspects of the proposed technique, or one or more example described above.

For example, for forming the ultrasonic assembly 1300 according to the method 1500, two MUTs packed in a respective WLB package may be provided, but the respective acoustic coupling medium is not yet formed on the MUTs. Then the two MUTs are assembled to the PCB. Only after assembly to the PCB, a respective acoustic coupling medium for acoustic coupling of the respective MUT to the external application surface is formed on each MUT such that the respective acoustic coupling medium formed on the respective MUT protrudes through a respective recess formed in the PCB.

Examples of the present disclosure may provide ultrasonic assemblies with one or more sensor chips assembled as WLB package onto a PCB (e.g., rigid or flexible) and pearing through a respective hole in the PCB.

Analogously to what is described above, forming the acoustic coupling medium on the at least one MUT may comprise dispensing a fluid or a gel as the acoustic coupling medium on the at least one MUT in the methods 1400 and 1500. Furthermore, forming the acoustic coupling medium on the at least one MUT may further comprise curing the dispensed fluid or gel in the methods 1400 and 1500.

### Aspects

The aspects described herein may be summarized as follows:
Aspect 1 is an ultrasonic device. The ultrasonic device comprises at least one MUT and processing circuitry electrically coupled to the at least one MUT. The at least one MUT and the processing circuitry are packed in an eWLB package. An acoustic coupling medium for acoustic coupling of the at least one MUT to an external application surface is formed on the at least one MUT.
Aspect 2 is the apparatus of aspect 1, wherein the processing circuitry is configured to: control the at least one MUT to selectively emit ultrasonic waves; and/or process one or more output signals of the at least one MUT, the one or more output signals being generated by the at least one MUT based on received ultrasonic waves.
Aspect 3 is the apparatus of aspect 1, wherein the ultrasonic device comprises a plurality of MUTs, and wherein the processing circuitry is configured to: control at least one of the plurality of MUTs to emit ultrasonic waves; and process one or more output signals of at least one of the plurality of MUTs, the one or more output signals being generated by the at least one of the plurality of MUTs based on received ultrasonic waves.
Aspect 4 is the ultrasonic device of any one of aspects 1 to 3, wherein the at least one MUT is embedded in a mold compound of the eWLB package, wherein one or more redistribution layers are formed on the mold compound for electrically coupling the processing circuitry to the at least one MUT, and wherein a recess is provided in the one or more redistribution layers for the acoustic coupling medium.
Aspect 5 is the ultrasonic device of aspect 4, wherein the recess is provided in the one or more redistribution layers at a position of the at least one MUT.
Aspect 6 is the ultrasonic device of aspect 4 or aspect 5, wherein a protrusion surrounding the recess is formed on the one or more redistribution layer.
Aspect 7 is the ultrasonic device of any one of aspects 4 to 6, further comprising one or more interconnects coupled to the processing circuitry via the one or more redistribution layers.
Aspect 8 is the ultrasonic device of any one of aspects 1 to 7, wherein the acoustic coupling medium is formed on a membrane of the at least one MUT.
Aspect 9 is the ultrasonic device of any one of aspects 1 to 8, wherein the acoustic coupling medium comprises silicone.
Aspect 10 is the ultrasonic device of any one of aspects 1 to 9, wherein the acoustic coupling medium is a gel.
Aspect 11 is the ultrasonic device of any one of aspects 1 to 10, wherein an acoustic impedance of the acoustic coupling medium is lower than an acoustic impedance of the at least one MUT.
Aspect 12 is an ultrasonic assembly. The ultrasonic assembly comprises a PCB and an ultrasonic device according to the first aspect. The ultrasonic device is assembled to the PCB. The acoustic coupling medium protrudes through a recess formed in the PCB.
Aspect 13 is the ultrasonic assembly of aspect 12, wherein one or more interconnects of the eWLB package are electrically coupled to one or more conductive traces on the PCB.
Aspect 14 is a method of forming an ultrasonic device. The method comprises providing an eWLB package. At least one MUT and a processing circuitry electrically coupled to the at least one MUT are packed in the eWLB package. Additionally, the method comprises forming an acoustic coupling medium for acoustic coupling of the at least one MUT to an external application surface on the at least one MUT.
Aspect 15 is a method of forming an ultrasonic assembly. The method comprises providing an eWLB package. At least one MUT and a processing circuitry electrically coupled to the at least one MUT are packed in the eWLB package. Additionally, the method comprises assembling the eWLB package to a PCB. A recess is provided in the PCB. The method further comprises forming an acoustic coupling medium for acoustic coupling of the at least one MUT to an external application surface on the at least one MUT after assembling the eWLB package to the PCB such that the acoustic coupling medium protrudes through the recess.
Aspect 16 is a method of forming an ultrasonic assembly. The method comprises providing an ultrasonic device according to any one of aspects 1 to 11 and assembling the ultrasonic device to a PCB such that the acoustic coupling medium protrudes through a recess formed in the PCB.
Aspect 17 is an ultrasonic assembly. The ultrasonic assembly comprises a PCB and additionally at least one MUT packed in a WLB package. The WLB package is assembled to the PCB. An acoustic coupling medium for acoustic coupling of the at least one MUT to an external application surface is formed on the at least one MUT such that the acoustic coupling medium protrudes through a recess formed in the PCB.
Aspect 18 is the ultrasonic assembly of aspect 17, wherein the ultrasonic assembly comprises at least two MUTs, and wherein the respective acoustic coupling medium formed on the respective MUT protrudes through a respective recess formed in the PCB.
Aspect 19 is the ultrasonic assembly of aspect 17 or aspect 18, further comprising processing circuitry assembled to the PCB and electrically coupled to the at least one MUT, wherein the processing circuitry is configured to: control the at least one MUT to selectively emit ultrasonic waves; and/or process one or more output signals of the at least one MUT, the one or more output signals being generated by the at least one MUT based on received ultrasonic waves.
Aspect 20 is a method of forming an ultrasonic assembly. The method comprises providing at least one MUT packed in a WLB package. An acoustic coupling medium for acoustic coupling of the at least one MUT to an external application surface is formed on the at least one MUT. In addition, the method comprises assembling the at least one MUT to a PCB such that the acoustic coupling medium protrudes through a recess formed in the PCB.
Aspect 21 is a method of forming an ultrasonic assembly. The method comprises providing at least one MUT packed in a WLB package. Additionally, the method comprises assembling the at least one MUT to a PCB. The method further comprises forming an acoustic coupling medium for acoustic coupling of the at least one MUT to an external application surface on the at least one MUT after assembling the at least one MUT to the PCB such that the acoustic coupling medium protrudes through the recess.
Aspect 22 is the method of any one of aspects 14, 15 and 21, wherein forming the acoustic coupling medium on the at least one MUT comprises dispensing a fluid or a gel as the acoustic coupling medium on the at least one MUT.
Aspect 23 is the method of aspect 22, wherein forming the acoustic coupling medium on the at least one MUT further comprises curing the dispensed fluid or gel.
Aspect 24: An ultrasonic device, comprising: at least one micromachined ultrasonic transducer (MUT); and processing circuitry electrically coupled to the at least one MUT, wherein the at least one MUT and the processing circuitry are arranged in an embedded wafer level ball grid array (eWLB) package, and wherein an acoustic coupling medium for acoustic coupling of the at least one MUT to an external application surface is formed on the at least one MUT.
Aspect 25: The ultrasonic device of Aspect 24, wherein the processing circuitry is configured to: control the at least one MUT to selectively emit ultrasonic waves, and process one or more output signals of the at least one MUT, wherein the at least one MUT is configured to generate the one or more output signals based on received ultrasonic waves.
Aspect 26: The ultrasonic device of any of Aspects 24-25, wherein the ultrasonic device comprises a plurality of MUTs, and wherein the processing circuitry is configured to: control at least a first one of the plurality of MUTs to emit ultrasonic waves, and process one or more output signals of at least a second one of the plurality of MUTs, the one or more output signals being generated by at least the second one of the plurality of MUTs based on received ultrasonic waves.
Aspect 27: The ultrasonic device of any of Aspects 24-26, wherein the at least one MUT is embedded in a mold compound of the eWLB package, wherein one or more redistribution layers are formed on the mold compound for electrically coupling the processing circuitry to the at least one MUT, and wherein a recess is provided in the one or more redistribution layers for accommodating the acoustic coupling medium.
Aspect 28: The ultrasonic device of Aspect 27, wherein the recess is provided in the one or more redistribution layers at a position of the at least one MUT.
Aspect 29: The ultrasonic device of Aspect 27, wherein a protrusion surrounding the recess is formed on the one or more redistribution layers.
Aspect 30: The ultrasonic device of Aspect 27, further comprising: one or more interconnects coupled to the processing circuitry via the one or more redistribution layers.
Aspect 31: The ultrasonic device of any of Aspects 24-30, wherein the acoustic coupling medium is formed on a membrane of each MUT of the at least one MUT.
Aspect 32: The ultrasonic device of any of Aspects 24-31, wherein the acoustic coupling medium comprises silicone.
Aspect 33: The ultrasonic device of any of Aspects 24-32, wherein the acoustic coupling medium is a gel.
Aspect 34: The ultrasonic device of any of Aspects 24-33, wherein an acoustic impedance of the acoustic coupling medium is lower than an acoustic impedance of the at least one MUT.
Aspect 35: An ultrasonic assembly comprising: a printed circuit board (PCB); and an ultrasonic device comprising: at least one micromachined ultrasonic transducer (MUT); processing circuitry electrically coupled to the at least one MUT; and an acoustic coupling medium formed on the at least one MUT and configured to acoustically couple the at least one MUT to an external application surface, wherein the at least one MUT and the processing circuitry are arranged in an embedded wafer level ball grid array (eWLB) package, wherein the ultrasonic device is assembled to the PCB, and wherein the acoustic coupling medium protrudes through a recess formed in the PCB.
Aspect 36: The ultrasonic assembly of Aspect 35, wherein one or more interconnects of the eWLB package are electrically coupled to one or more conductive traces on the PCB.
Aspect 37: A method of forming an ultrasonic device, the method comprising:
providing an embedded wafer level ball grid array (eWLB) package, wherein at least one micromachined ultrasonic transducer (MUT) and a processing circuitry electrically coupled to the at least one MUT are provided in the eWLB package; and forming an acoustic coupling medium for acoustic coupling of the at least one MUT to an external application surface on the at least one MUT.
Aspect 38: A method of forming an ultrasonic assembly, the method comprising: providing an embedded wafer level ball grid array (eWLB) package, wherein at least one micromachined ultrasonic transducer (MUT) and a processing circuitry electrically coupled to the at least one MUT are provided in the eWLB package; assembling the eWLB package to a printed circuit board (PCB), wherein a recess is provided in the PCB; and forming an acoustic coupling medium for acoustic coupling of the at least one MUT to an external application surface on the at least one MUT after assembling the eWLB package to the PCB such that the acoustic coupling medium protrudes through the recess.
Aspect 39: A method of forming an ultrasonic assembly, the method comprising: providing an ultrasonic device comprising: at least one micromachined ultrasonic transducer (MUT); processing circuitry electrically coupled to the at least one MUT; and an acoustic coupling medium formed on the at least one MUT and configured to acoustically couple the at least one MUT to an external application surface, wherein the at least one MUT and the processing circuitry are arranged in an embedded wafer level ball grid array (eWLB) package; and assembling the ultrasonic device to a printed circuit board (PCB) such that the acoustic coupling medium protrudes through a recess formed in the PCB.
Aspect 40: An ultrasonic assembly, comprising: a printed circuit board (PCB); and a first micromachined ultrasonic transducer (MUT) provided in a wafer level ball grid array (WLB) package, wherein the WLB package is assembled to the PCB, and wherein a first acoustic coupling medium for acoustic coupling of the first MUT to an external application surface is formed on the first MUT such that the first acoustic coupling medium protrudes through a first recess formed in the PCB.
Aspect 41: The ultrasonic assembly of Aspect 40, further comprising: a second MUT provided in the WLB package; and a second acoustic coupling medium for acoustic coupling of the second MUT to the external application surface, wherein the second acoustic coupling medium is formed on the second MUT such that the second acoustic coupling medium protrudes through a second recess formed in the PCB.
Aspect 42: The ultrasonic assembly of any of Aspects 40-41, further comprising: processing circuitry assembled to the PCB and electrically coupled to the first MUT, wherein the processing circuitry is configured to: control the first MUT to selectively emit ultrasonic waves, or process one or more output signals of the first MUT, the one or more output signals being generated by the first MUT based on received ultrasonic waves.
Aspect 43: A method of forming an ultrasonic assembly, the method comprising: providing at least one micromachined ultrasonic transducer (MUT) in a wafer level ball grid array (WLB) package, wherein an acoustic coupling medium for acoustic coupling of the at least one MUT to an external application surface is formed on the at least one MUT; and assembling the at least one MUT to a printed circuit board (PCB) such that the acoustic coupling medium protrudes through a recess formed in the PCB.
Aspect 44: A method of forming an ultrasonic assembly, the method comprising: providing at least one micromachined ultrasonic transducer (MUT) in a wafer level ball grid array (WLB) package; assembling the at least one MUT to a printed circuit board (PCB); and forming an acoustic coupling medium for acoustic coupling of the at least one MUT to an external application surface on the at least one MUT after assembling the at least one MUT to the PCB such that the acoustic coupling medium protrudes through a recess formed in the PCB.
Aspect 45: The method of Aspect 44, wherein forming the acoustic coupling medium on the at least one MUT comprises dispensing a fluid or a gel as the acoustic coupling medium on the at least one MUT.
Aspect 46: The method of Aspect 45, wherein forming the acoustic coupling medium on the at least one MUT further comprises curing the fluid or the gel on the at least one MUT.
Aspect 47: A system configured to perform one or more operations recited in one or more of Aspects 1-46.
Aspect 48: An apparatus comprising means for performing one or more operations recited in one or more of Aspects 1-46.

The aspects and features described in relation to a particular one of the previous aspects may also be combined with one or more of the further aspects to replace an identical or similar feature of that further aspect or to additionally introduce the features into the further aspect.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further aspects, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other aspects may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An ultrasonic device, comprising:
at least one micromachined ultrasonic transducer (MUT); and
processing circuitry electrically coupled to the at least one MUT,
wherein the at least one MUT and the processing circuitry are arranged in an embedded wafer level ball grid array (eWLB) package, and
wherein an acoustic coupling medium for acoustic coupling of the at least one MUT to an external application surface is formed on the at least one MUT.

2. The ultrasonic device of claim 1, wherein the processing circuitry is configured to:
control the at least one MUT to selectively emit ultrasonic waves, and
process one or more output signals of the at least one MUT, wherein the at least one MUT is configured to generate the one or more output signals based on received ultrasonic waves.

3. The ultrasonic device of claim 1, wherein the ultrasonic device comprises a plurality of MUTs, and wherein the processing circuitry is configured to:
control at least a first one of the plurality of MUTs to emit ultrasonic waves, and
process one or more output signals of at least a second one of the plurality of MUTs, the one or more output signals being generated by at least the second one of the plurality of MUTs based on received ultrasonic waves.

4. The ultrasonic device of claim 1, wherein the at least one MUT is embedded in a mold compound of the eWLB package,
wherein one or more redistribution layers are formed on the mold compound for electrically coupling the processing circuitry to the at least one MUT, and
wherein a recess is provided in the one or more redistribution layers for accommodating the acoustic coupling medium.

5. The ultrasonic device of claim 4, wherein the recess is provided in the one or more redistribution layers at a position of the at least one MUT.

6. The ultrasonic device of claim 4, wherein a protrusion surrounding the recess is formed on the one or more redistribution layers.

7. The ultrasonic device of claim 4, further comprising:
one or more interconnects coupled to the processing circuitry via the one or more redistribution layers.

8. The ultrasonic device of claim 1, wherein the acoustic coupling medium is formed on a membrane of each MUT of the at least one MUT.

9. The ultrasonic device of claim 1, wherein the acoustic coupling medium comprises silicone.

10. The ultrasonic device of claim 1, wherein the acoustic coupling medium is a gel.

11. The ultrasonic device of claim 1, wherein an acoustic impedance of the acoustic coupling medium is lower than an acoustic impedance of the at least one MUT.

12. An ultrasonic assembly, comprising:
a printed circuit board (PCB); and
an ultrasonic device comprising:
at least one micromachined ultrasonic transducer (MUT);
processing circuitry electrically coupled to the at least one MUT; and
an acoustic coupling medium formed on the at least one MUT and configured to acoustically couple the at least one MUT to an external application surface,
wherein the at least one MUT and the processing circuitry are arranged in an embedded wafer level ball grid array (eWLB) package,
wherein the ultrasonic device is assembled to the PCB, and wherein the acoustic coupling medium protrudes through a recess formed in the PCB.

13. The ultrasonic assembly of claim 12, wherein one or more interconnects of the eWLB package are electrically coupled to one or more conductive traces on the PCB.

14. A method of forming an ultrasonic device, the method comprising:
providing an embedded wafer level ball grid array (eWLB) package, wherein at least one micromachined ultrasonic transducer (MUT) and a processing circuitry electrically coupled to the at least one MUT are provided in the eWLB package; and
forming an acoustic coupling medium for acoustic coupling of the at least one MUT to an external application surface on the at least one MUT.

15. A method of forming an ultrasonic assembly, the method comprising:
providing an embedded wafer level ball grid array (eWLB) package, wherein at least one micromachined ultrasonic transducer (MUT) and a processing circuitry electrically coupled to the at least one MUT are provided in the eWLB package;
assembling the eWLB package to a printed circuit board (PCB), wherein a recess is provided in the PCB; and
forming an acoustic coupling medium for acoustic coupling of the at least one MUT to an external application surface on the at least one MUT after assembling the eWLB package to the PCB such that the acoustic coupling medium protrudes through the recess.

16. A method of forming an ultrasonic assembly, the method comprising:
providing an ultrasonic device comprising:
at least one micromachined ultrasonic transducer (MUT);
processing circuitry electrically coupled to the at least one MUT; and
an acoustic coupling medium formed on the at least one MUT and configured to acoustically couple the at least one MUT to an external application surface,
wherein the at least one MUT and the processing circuitry are arranged in an embedded wafer level ball grid array (eWLB) package; and
assembling the ultrasonic device to a printed circuit board (PCB) such that the acoustic coupling medium protrudes through a recess formed in the PCB.

17. An ultrasonic assembly, comprising:
a printed circuit board (PCB); and
a first micromachined ultrasonic transducer (MUT) provided in a wafer level ball grid array (WLB) package,
wherein the WLB package is assembled to the PCB, and
wherein a first acoustic coupling medium for acoustic coupling of the first MUT to an external application surface is formed on the first MUT such that the first acoustic coupling medium protrudes through a first recess formed in the PCB.

18. The ultrasonic assembly of claim 17, further comprising:
a second MUT provided in the WLB package; and
a second acoustic coupling medium for acoustic coupling of the second MUT to the external application surface, wherein the second acoustic coupling medium is formed on the second MUT such that the second acoustic coupling medium protrudes through a second recess formed in the PCB.

19. The ultrasonic assembly of claim 17, further comprising:
processing circuitry assembled to the PCB and electrically coupled to the first MUT, wherein the processing circuitry is configured to:
control the first MUT to selectively emit ultrasonic waves, or
process one or more output signals of the first MUT, the one or more output signals being generated by the first MUT based on received ultrasonic waves.

20. A method of forming an ultrasonic assembly, the method comprising:
providing at least one micromachined ultrasonic transducer (MUT) wafer level ball grid array (WLB) package, wherein an acoustic coupling medium for acoustic coupling of the at least one MUT to an external application surface is formed on the at least one MUT; and
assembling the at least one MUT to a printed circuit board (PCB) such that the acoustic coupling medium protrudes through a recess formed in the PCB.

21. A method of forming an ultrasonic assembly, the method comprising:
providing at least one micromachined ultrasonic transducer (MUT) in a wafer level ball grid array (WLB) package;
assembling the at least one MUT to a printed circuit board (PCB); and
forming an acoustic coupling medium for acoustic coupling of the at least one MUT to an external application surface on the at least one MUT after assembling the at least one MUT to the PCB such that the acoustic coupling medium protrudes through a recess formed in the PCB.

22. The method of claim 21, wherein forming the acoustic coupling medium on the at least one MUT comprises dispensing a fluid or a gel as the acoustic coupling medium on the at least one MUT.

23. The method of claim 22, wherein forming the acoustic coupling medium on the at least one MUT further comprises curing the fluid or the gel on the at least one MUT.
